(19) United States
(12) Patent Application Publication
(10) Pub. No.: US 2005/0265271 A1
(43) Pub. Date: Dec. 1, 2005

(54) System and method for constructing a distributive wireless controller

(76) Inventor: Howard Mark Garon, Silver Spring, MD (US)

Correspondence Address: Howard Mark Garon, 13532 Montvale Drive, Silver Spring, MD, 20904-1109, US

(21) Appl. No.: 10/709,437

(22) Filed: May 5, 2004

(51) Int. Cl. H04L 12/16

(52) U.S. Cl. 370/313

(57) ABSTRACT

This invention provides a system and method for constructing, establishing and deploying a distributive wireless command and control system utilizing the internet to facilitate that command and control. Each and every aspect of this system is designed to provide alternative means of maintaining the complete command and control communication link over every portion of that link. Should any portion of the link fail an alternative will be substituted until all alternatives have been exhausted. One specific realization of the invention is disclosed for the complete wireless command and control of Dynamic Message Signs (DMA), Changeable Message Signs (CMS) and Variable Message Signs (VMS).

### BACKGROUND OF INVENTION

Quite often multiple communication protocols are required in order to assure a high level of confidence in maintaining wireless communication links. The command and control problem associated with these critical links then corresponds to being able to switch between the various communication protocols and modalities in a seamless fashion. Additionally, the decision to switch may be dictated not just by the state of the communication channel but also simple economics all other factors being equal, it is usually cheaper to employ one communication modality over another. If the communication link can be maintained and assured with more than one protocol or modality and it is important to simultaneously reduce the overall cost of communications then the cheaper or cheapest protocol or modality should be selected and employed.

All current wireless command and control systems are lacking in one or more of the important properties and characteristics of the invention described herein. They may lack a cohesive and singular interface to control multiple devices in the field almost simultaneously or multiple means of maintaining a communication link should one portion of that link fail. Each and every aspect of this system is designed to provide alternative means of maintaining the communication link over every part of that link.

One application of this invention is to the command and control of Dynamic Message Signs, Changeable Message Signs (CMS) and Variable Message Signs (VMS). These are electronic displays and signs that are frequently employed by a number of State Departments of Transportation, contractors and associated personnel for many useful purposes.

The fundamental purpose of these signs is to inform the public of traffic hazards, weather alerts, and special events and thus achieve either enhanced traffic flow control or expanded promulgation of an alarm or alert. Prior to this invention most signs had to be set up manually at each particular sign console. Some sign manufacturers did provide limited wired or wireless remote command and control.

The wired connections have failed in a number of critical instances, especially where there was major damage to the infrastructure as a result of a storm, earthquake or fire. In all cases prior to this invention, wireless sign control was extremely limited in the sense that only one sign at a time could be addressed for command and control and the wireless link was tenuous at best. There was no way to assure that a message was received by the sign correctly and that the sign executed the command/control properly. For critical communications involving life-threatening alerts this method and system were unacceptable. This invention removes or minimizes the shortcomings of all of these shortcomings and others well known to those familiar with the field.

### SUMMARY OF INVENTION

This invention provides a system and method for constructing, establishing and deploying a distributive wireless command and control system utilizing the internet to facilitate that command and control.

Almost all commercial communication modalities and protocols are accessible via the internet. With proper hardware and software design, an internet server may be utilized to integrate as many of these modalities and protocols as necessary to establish an efficacious and ubiquitous means of device command and control, and thus permit the system and method to automatically and autonomously optimize the communications channel. The system and method also allows for the inclusion of an operator to manually optimize the communications channel should the automatic selection fail.

### DETAILED DESCRIPTION

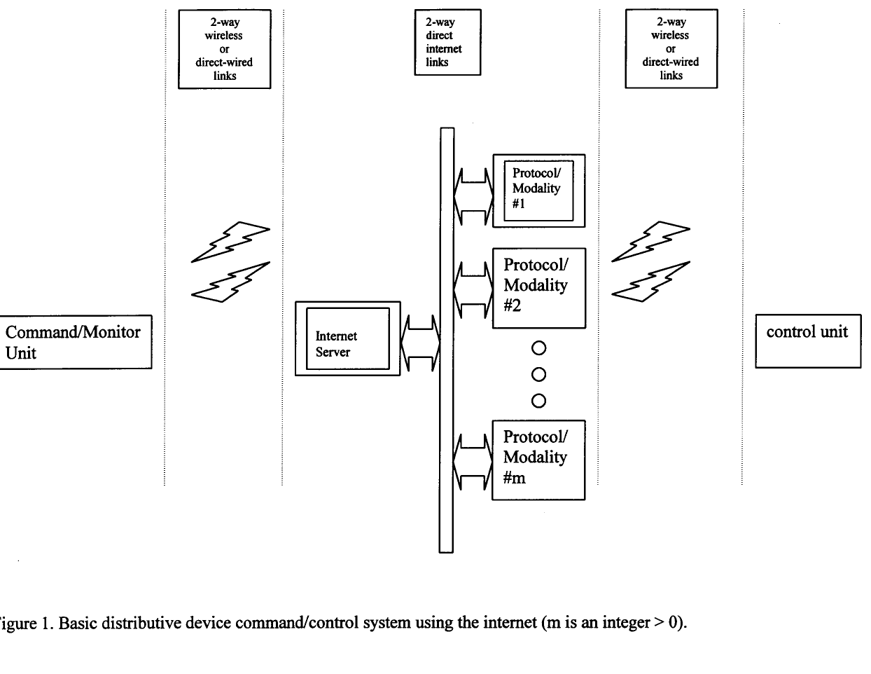

One such realization of the system is shown in the block diagram of FIG. 1. The basic constituents consist of a command/monitor unit capable of connecting to the internet, a controller interface also capable of connecting to the internet, the object or device to be commanded/monitored, and finally, an internet server.

The internet server translates the commands from the command/monitor unit, selects and optimizes the communication modality and protocol to the controller interface box, and subsequently transfers those commands to the controller interface. The controller interface will in turn issue the transmitted commands in an appropriate format to the device under control. If status or alarms are issued by the device under control, the reverse channel is employed. The reverse channel requires the controller interface to initiate a data transmission back to the server via the internet. The server then translates this reverse-path data transmission into a form and format suitable to be viewed and interpreted properly by the command/monitor unit.

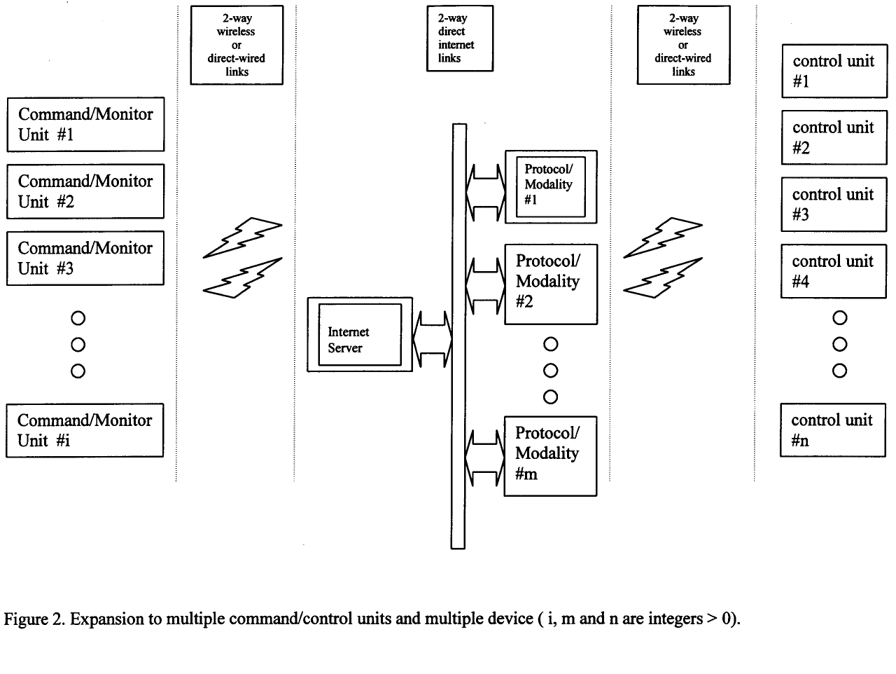

This system may be further generalized as illustrated in FIG. 2 by extending the system to an arbitrary number of command/monitor units and, similarly, to an arbitrary number of controller interfaces

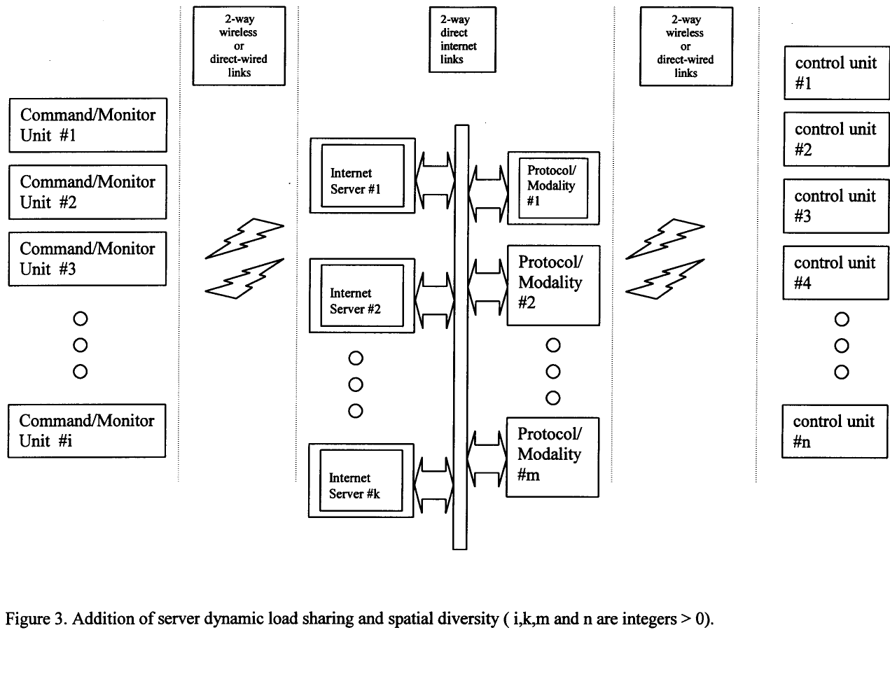

Finally, as in FIG. 3, the system can be extended from the single server to multiple servers, simultaneously introducing spatial diversity and load sharing.

In all these realizations as well as those not discussed here, we place no restrictions or limits on how the internet connections are to be accomplished, only that we wish to include, at the very least, all direct (wired) methods of connection and all wireless means of connections, both terrestrial and satellite based.

In the specific application of Dynamic Message Signs (DMS), Changeable Message Signs (CMS) and Variable Message Signs (VMS) the command/control unit is usually placed within each State Department of Transportation (DOT) command and control center. The intent on introducing this specific appliciation is not to limit the scope of applicability of the invention, instead the intent is to illustrate just one instance where the invention may be of significance. With this invention command and control is no longer parochial to the DOT command and control center, command and control can be established from absolutely anywhere with access to the internet, no matter how that access is obtained, permitting community, city, state and national timely relay and rebroadcast of traffic, weather, special danger and threat alerts and warnings. These alerts and warnings may include those issued by the well-established national radio broadcast alert system, the more recent lost or kidnapped child alert program and the Homeland Security administration. Should the primary system command center become inoperable for any reason then sign control can easily be re-established from any secondary site.

This invention permits command and control to be extended to almost an unlimited number of signs, nearly simultaneously, with a single command, again, from any place which can establish access to the internet.

The single command can be interpreted by one or more special internet servers which can calculate the effective communication load requirements in order to accommodate all the protocols and modalities that may be necessary to successfully communicate with all signs. The single command can then be dispersed accordingly across the requisite protocols and modalities to eventually to be received by the intended signs. Each sign in turn would indicate on the reverse channel whether it had received the command/control and whether or not the command/control had been successfully executed. If the command/control had not executed properly at the sign then the sign would return the proper diagnostic or error code. If the command/control had failed prior to being received by the sign then the channel would indicate a transmission failure back to the responsible server. In the scenario where the transmission failed to reach the sign, the server would choose an alternate communication protocol and/or modality and attempt the transmission again. This would continue until the sign indicated that the transmission had been received or all available protocols and modalities had been exhausted.

1. A method for the asynchronous and synchronous direct (wired) command and control of multiple and spatially disparate devices via the internet using single or multiple internet servers to facilitate that command and control.

2. A method for the asynchronous and synchronous wireless command and control of multiple and spatially disparate devices via the internet using single or multiple internet servers to facilitate that command and control.

3. A method for optimizing the forward and reverse communications paths, modalities and protocols between internet server and target device.

4. A method employing any and all claims 1-3 for the command and control of Dynamic Message Signs (DMS), Changeable Message Signs (CMS) and Variable Message Signs (VMS), either fixed, portable or mobile.

5. A system employing any and all claims 1-3 for the command and control of Dynamic Message Signs (DMS), Changeable Message Signs (CMS) and Variable Message Signs (VMS), either fixed, portable or mobile.
